(19) United States
(12) Patent Application Publication
(10) Pub. No.: US 2022/0397304 A1
(43) Pub. Date: Dec. 15, 2022

(54) GLUE REWARMING DEVICE

(71) Applicant: TRIPLE WIN TECHNOLOGY(SHENZHEN) CO.LTD., Shenzhen (CN)

(72) Inventor: YING-LI XIE, Shenzhen (CN)

(21) Appl. No.: 17/687,914

(22) Filed: Mar. 7, 2022

(30) Foreign Application Priority Data
Jun. 11, 2021 (CN) 202110656046.9

(51) Int. Cl. F24H 9/20; F24H 15/128; F24H 15/486; F24H 9/02

(52) U.S. Cl. CPC F24H 9/20; F24H 15/128; F24H 15/486; F24H 9/02

(57) ABSTRACT

A glue rewarming device includes a glue pipe, a main body, a plurality of temperature sensors, a timer, and a control terminal. Each glue pipe is configured to receive glue. The main body defines the grooves spaced apart from each other. Each groove is configured to receive one glue pipe. Each temperature sensor is in one groove and on an inner wall of the one groove. The temperature sensor is configured to sense a temperature of the glue in the glue pipe inserted into the corresponding groove. The timer is configured to record a time point when the glue pipe is placed in one groove and a time length from the time point when the glue pipe is placed in one groove to the time when the glue in the glue pipe reaches a target temperature. The control terminal is electrically connected to the timer and the temperature sensors.

### FIELD

The subject matter herein generally relates to a glue rewarming device.

### BACKGROUND

In industrial production, glue is usually stored at a low temperature, and it is necessary to heat the refrigerated glue to an applicable temperature before use. At present, rewarming condition of the glue is mainly observed manually frequently, and the temperature increasing time is manually operated and recorded. Such a method is not conducive to operation and low efficiency, but also may cause decreasing of glue quality because of insufficient rewarming time or cause glue overflow because of the glue temperature increasing time being too long.

Therefore, there is room for improvement in the art.

### BRIEF DESCRIPTION OF THE DRAWINGS

Implementations of the present technology will now be described, by way of embodiments only, with reference to the attached figures.

FIG. 1 is an isometric view of a glue rewarming device of a first embodiment according to the present disclosure.

FIG. 2 is an isometric view of the glue rewarming device showing a cover of a main body in a closed state.

FIG. 3 is another isometric view of the glue rewarming device of the first embodiment of the present disclosure.

FIG. 4 is an isometric view of a temperature sensor of the glue rewarming device of the first embodiment of the present disclosure.

FIG. 5 is an isometric view of a glue rewarming device of a second embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

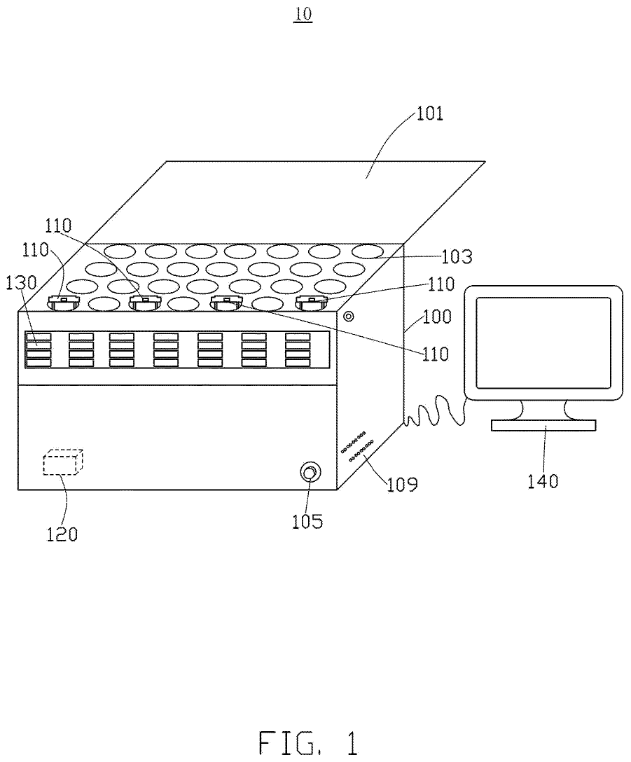

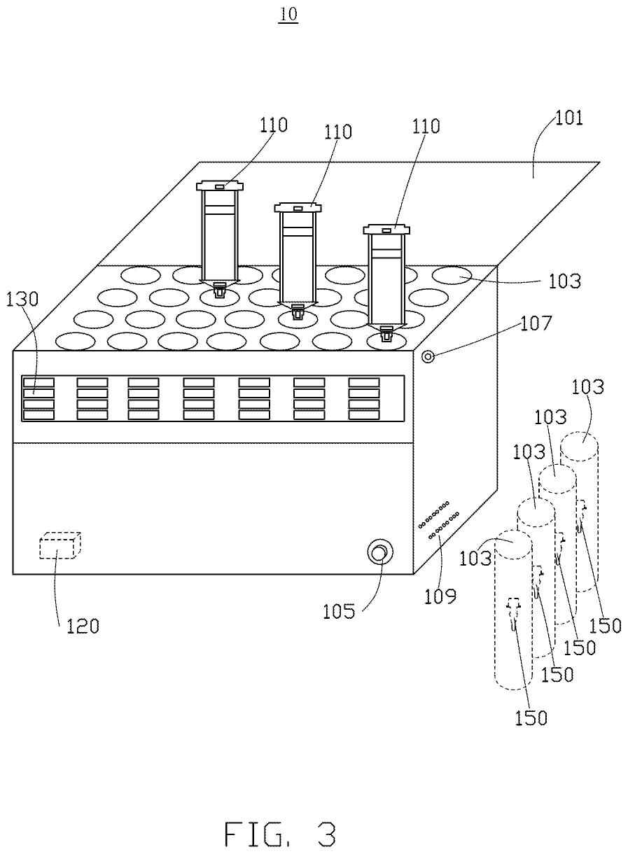

FIG. 1 shows a glue rewarming device 10 of a first embodiment. The glue rewarming device 10 includes a main body 100 and a plurality of glue pipes 110. Each glue pipe 110 is used to receive glue. The main body 100 defines a plurality of grooves 103 spaced apart from each other. Each groove 103 is used to place one glue pipe 110, and each glue pipe 110 is inserted into one groove 103. The glue pipe 110 can be designed into different sizes according to actual situation. In this embodiment, a cross-sectional diameter of the glue pipe 110 is about 27 mm. Optionally, a size and a shape of the groove 103 match a size and a shape of the glue pipe 110, and the groove 103 can be designed into different sizes according to the shape and size of the glue pipe 110. As shown in FIG. 3, in this embodiment, each glue pipe 110 is substantially in a hollow cylindrical shape to receive glue; and each groove 103 is cylindrical. In the glue heating process, a same kind of glue or different kinds of glue can be received in different glue pipes 110 according to the actual situation.

The glue rewarming device 10 in this embodiment is used to increasing a temperature of the glue in a non-heating way, and a temperature of the glue is increased to be a target temperature by placing the glue pipe 110 in a natural environment (a room temperature environment).

As shown in FIG. 1, a timer 120 and a display device 130 are set in the main body 100. The timer 120 is electrically connected to the display device 130. The timer 120 is used to record a time point when the glue pipe 110 is placed in one corresponding groove 103, and record a time length from the time when the glue pipe 110 is placed in the corresponding groove 103 to a time when a temperature of the glue in the glue pipe 110 reaches a target temperature. The timer 120 starts timing when the glue pipe 110 is placed in the corresponding one groove 103. The timer 120 has a 24-hour timing function. The display device 130 is used to display the start time when the glue pipe 110 is placed in the corresponding one groove 103 and a real-time temperature of the glue in the glue pipe 110.

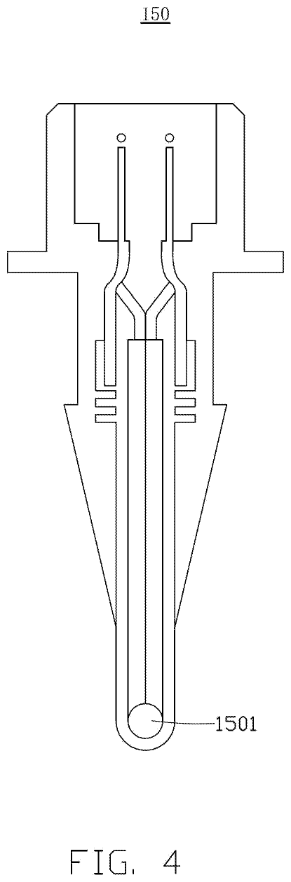

As shown in FIG. 3, a plurality of temperature sensors 150 are set in the main body 100. Each groove 103 is correspondingly provided with one temperature sensor 150. In this embodiment, the temperature sensor 150 is a contact temperature sensor and can be arranged on an inner wall of the groove 103. As shown in FIG. 4, the temperature sensor 150 includes a thermistor 1501 arranged at a bottom. The temperature sensor 150 is used to measure a temperature of the glue in the glue pipe 110 inserted into the corresponding groove 103; and the temperature sensor 150 can sense a variation of the temperature and convert the variation of the temperature into an electrical signal. The temperature range measured by the temperature sensor 150 is from −40° C. to 10° C., and the measured deviation value is ±2° C. After the glue pipe 110 is filled with glue, the glue pipe 110 is placed in the groove 103 and contact the temperature sensor 150, and a resistance value of the thermistor 1501 will change according to the temperature of the glue to output different electrical signals to measure the temperature of the glue. The thermistor 1501 may have a positive temperature coefficient and have a greater resistance value when the temperature is higher. Alternatively, the thermistor 1501 may have a negative temperature coefficient and have a lower resistance value when the temperature is higher. The display device 130 displays the time point when the glue pipe 110 is inserted into the corresponding groove 103 and the real-time temperature measured by the corresponding temperature sensor 150. The temperature sensor 150 is a contact temperature sensor. When the glue pipe 110 containing glue is inserted in any of the grooves 103, the temperature sensor 150 contacts the glue pipe 110 and measures the temperature of the glue in the glue pipe 110 in real-time.

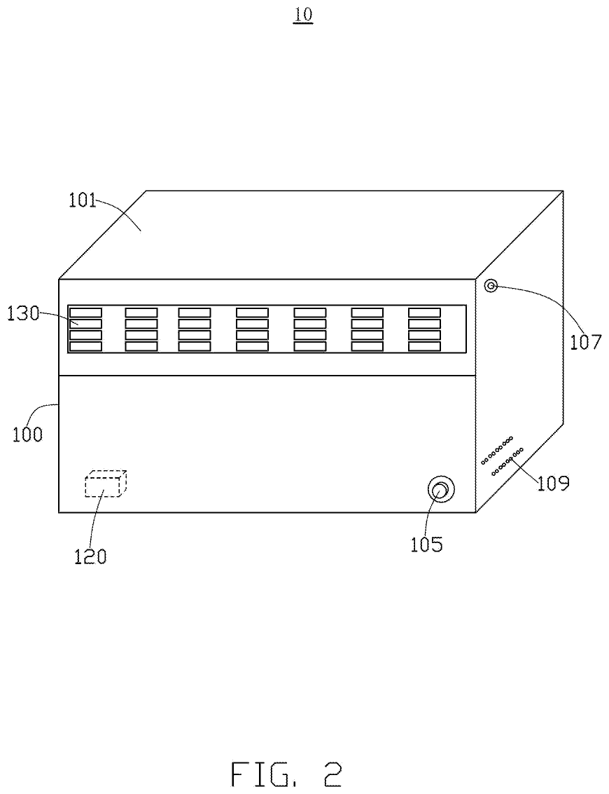

As shown in FIG. 2, the glue rewarming device 10 also includes a control terminal 140. The control terminal 140 is arranged separately from the glue rewarming device 10. The control terminal 140 can communicately coupled to the glue rewarming device 10 by a bus. Or the control terminal 140 and the glue rewarming device 10 realize wireless communication connection to each other by wireless communication methods, such as Bluetooth and Wi-Fi. The control terminal 140 may be a computer, tablet computer, mobile phone, etc. In this embodiment, the control terminal 140 is connected to the glue rewarming device by a bus, and the control terminal 140 is a computer. The control terminal (computer) 140 is electrically connected to the timer 120 and the temperature sensor 150. The control terminal (computer) 140 can be connected to the network to collect big data on the temperature increasing efficiency of the glue of different types (different components), and analyze whether the temperature increasing of the glue contained in the groove 103 is abnormal according to the real-time temperature measured by the temperature sensor 150 and the time recorded by the timer 120.

In one embodiment, the temperature increasing efficiency refers to a temperature of the glue increasing in a unit time during the glue reaches a target temperature. The unit time can be one second, one minute, etc. The temperature increasing efficiency can be expressed in a form of a standard curve or stored in the control terminal 140 in a form of a data table. When a temperature of the glue in any glue pipe 110 reaches the target temperature, the control terminal 140 will record the temperature increasing of the glue and compare the temperature increasing efficiency of the glue with a general temperature increasing efficiency of the glue; and the user can make a specific analysis on the glue with a large deviation between the actual temperature increasing efficiency and the general temperature increasing efficiency of this kind of glue, and then judge whether there are abnormal conditions affecting the normal use of the industry according to the actual situation.

When a cold glue pipe 110 is inserted into the corresponding groove 103, the temperature sensor 150 senses the variation of the temperature and outputs a signal to the timer 120, and the timer 120 starts timing. When the temperature sensor 150 measures that a temperature of the glue in the glue pipe 110 reaches the target temperature set in the control terminal (computer) 140 in advance, the timer 120 will receive the signal output by the temperature sensor 150 and stop timing.

Referring to FIG. 3, the main body 100 is provided with an indication lamp 107, a power switch 105, and a speaker 109. When the power switch 105 is turned on, the indication lamp 107 emits light; when the power switch 105 is turned off, the indicator 107 does not light up. The power switch 105 is electrically connected to an electronic component of the glue rewarming device 10, such as the timer 120, the display device 130, the temperature sensor 150, the indication lamp 107 or the speaker 109. When a temperature of the glue in the corresponding groove 103 reaches the target temperature, the speaker 109 will receive the signal output by the temperature sensor 150 and send an alarm to remind the user that the glue has reached the target temperature. Optionally, when the power switch 105 is turned on, the indication lamp 107 can be a blue light or a red light or other color light according to the actual situation. In this embodiment, the indication lamp 107 emits green light.

As shown in FIG. 1 and FIG. 2, the main body 100 includes a protective cover 101. When the glue rewarming device 10 is in the working state, the protective cover 101 can be closed to protect the glue pipes 110 receiving glue, prevent external impurities from entering the glue pipe 110 and ensure the normal operation of the glue rewarming device 10.

When the glue stored in cold storage needs to be used, the glue needs to rise to a certain target temperature before it can be used. Open the protective cover 101 and turn on the power switch 105 of the main body 100 of the glue rewarming device 10, and the indication lamp 107 lights up. Put a glue pipe 110 containing glue into any groove 103, the timer 120 starts timing, and the temperature sensor 150 senses the temperature of the glue in real time. The display device 130 displays the temperature of the glue and the time point when the glue pipe is put into the groove 103 in real time. The control terminal 140 (such as computer) analyzes a theoretical time required for the glue to reach the target temperature according to the type, nature and current temperature of the glue to be warmed. The control terminal 140 automatically records the temperature increasing of the glue. When the glue reaches the target temperature, the timer 120 will receive the signal output by the temperature sensor 150, the timer 120 will stop timing, record the time taken for the glue to reach the target temperature and transmit the signal to the speaker 109, and the speaker 109 will send an alarm to prompt the user to open the protective cover 101 to take out the glue pipe 110. At this time, the control terminal 140 will analyze the temperature increasing of the glue to track whether each glue is abnormal. When the user completes the use of the glue warming device 10, the power switch 105 can be turned off, and the indication lamp 107 will be turned off.

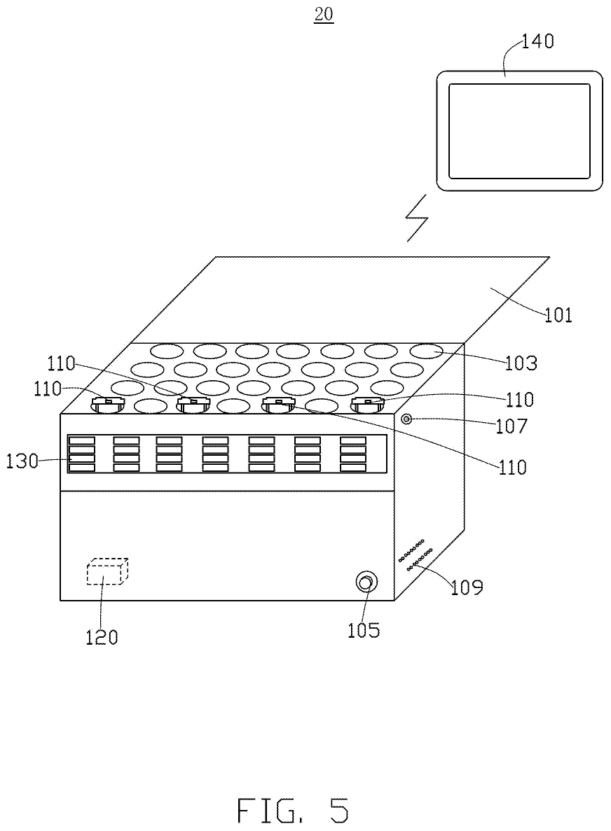

As shown in FIG. 5, the glue rewarming device 20 of the second embodiment of the disclosure is basically similar to the glue rewarming device 10, except that the control terminal 140 of the glue rewarming device 20 is wirelessly connected to the glue rewarming device 20, and the control terminal 140 can be connected to the control terminal 140 by Bluetooth or Wi-Fi. In this embodiment, the control terminal 140 is a tablet computer connected to the glue temperature rewarming device 20 by Wi-Fi. In this embodiment, the glue rewarming device 10 is used for the glue rewarming process. When the refrigerated glue needs to be used, it needs to rise to a certain target temperature before it can be used, open the protective cover 101 and turn on the power switch 105 of the main body 100 of the glue rewarming device 10, and the indication lamp 107 lights up. Put the glue pipe 110 containing glue into any groove 103, the timer 120 starts timing, and the temperature sensor 150 senses the temperature of the glue in real time. The display device 130 displays the temperature of the glue and the time point when the glue pipe is put into the groove 103 in real time. The control terminal 140 (such as tablet computer) analyzes a theoretical time required for the glue to reach the target temperature according to the type, nature and current temperature of the glue to be warmed. The control terminal 140 automatically records the temperature increasing of the glue. When the glue reaches the target temperature, the timer 120 will receive the signal output by the temperature sensor 150, the timer 120 will stop timing, record the time taken for the glue to reach the target temperature and transmit the signal to the speaker 109, and the speaker 109 will send an alarm to prompt the user to open the protective cover 101 to take out the glue pipe 110. At this time, the control terminal 140 will analyze the temperature increasing of the glue to track whether each glue is abnormal. When the user completes the use of the glue warming device 10, the power switch 105 can be turned off, and the indication lamp 107 will be turned off.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A glue rewarming device comprising:
at least one glue pipe, each of the at least one glue pipe configured to receive glue;
a main body, the main body defining a plurality of grooves spaced apart from each other, each of the plurality of grooves configured to receive one of the at least one glue pipe;
a plurality of temperature sensors, each of the plurality of temperature sensors being in one of the plurality of grooves and on an inner wall of the one of the plurality of grooves, and the temperature sensor configured to sense a temperature of the glue in the glue pipe;
a timer on the main body, the timer configured to record a time point when the glue pipe is placed in one of the plurality of grooves and a time period from the time point when the glue pipe is placed in the corresponding one groove to a time point when the glue in the glue pipe reaches a target temperature; and
a control terminal, the control terminal electrically connected to the timer and the plurality of temperature sensors, the control terminal configured for networking to collect big data on the temperature increasing efficiency of different types of glues, and analyzing whether an increase of the temperature of the glue is abnormal according to a real-time temperature measured by the temperature sensor and the time period recorded by the timer.

2. The glue rewarming device of claim 1, further comprising a display device; wherein the display device is arranged on the main body; the display device is configured to display temperatures of the glue in the glue pipe in real time according to the temperature sensor and display the time point when the glue pipe is put into the corresponding groove according to the timer.

3. The glue rewarming device of claim 1, wherein each of the plurality of temperature sensors comprises a thermistor.

4. The glue rewarming device of claim 1, wherein the main body further comprises a speaker, the speaker is configured to receive signals from each of the plurality of temperature sensors and give an alarm when the glue in the glue pipe reaches the target temperature.

5. The glue rewarming device of claim 1, wherein each of the plurality of temperature sensors is a contact type temperature sensor; when the glue pipe is inserted into one of the plurality of grooves, the temperature sensor senses the temperature and outputs a signal to prompt the timer to start timing.

6. The glue rewarming device of claim 1, wherein the control terminal is electrically coupled to the main body by buses.

7. The glue rewarming device of claim 1, wherein the control terminal is electrically coupled to the main body by wireless communication connections.

8. The glue rewarming device of claim 1, wherein the plurality of grooves have different opening sizes.

9. The glue rewarming device of claim 1, wherein the main body part further comprises a power switch, the power switch is configured to control an on or off state of electronic components of the glue rewarming device.

10. The glue rewarming device of claim 1, wherein the main body part further comprises an indication lamp indicating that the glue rewarming device is in a working state.

11. The glue rewarming device of claim 1, wherein a measured temperature range of each of the plurality of temperature sensors is −40° C. to −10° C.
